(19) United States
(12) Patent Application Publication
(10) Pub. No.: US 2003/0172253 A1
(43) Pub. Date: Sep. 11, 2003

(54) Fast instruction dependency multiplexer

(75) Inventors: Karthik Balakrishnan, Sunnyvale, CA (US); Poonacha P. Kongetira, Menlo Park, CA (US); Sanjay Patel, Fremont, CA (US); Ketaki Rao, Sunnyvale, CA (US)

Correspondence Address: ZAGORIN O'BRIEN & GRAHAM LLP, 401 W 15TH STREET, SUITE 870, AUSTIN, TX, 78701, US

(73) Assignee: Sun Microsystems, Inc.

(21) Appl. No.: 10/091,783

(22) Filed: Mar. 6, 2002

(51) Int. Cl. G06F 9/30

(52) U.S. Cl. 712/217

(57) ABSTRACT

According to an embodiment of the present invention, a method and apparatus is described for selecting dependencies between a fast scoreboard and a slow scoreboard in an out of order processor. The processor fetches instructions in groups eight instructions. Each group of eight instructions is mod-eight rotated. The instructions in the scoreboards are configured into multiple octets. A select mask for the first instruction of each octet is generated using a predefined truth table. The select masks for remaining instructions in the octets are generated using the first mask. The write pointer for the current instruction is used to select the masks for the group of eight instructions. The selected masks are then used to multiplex dependencies between the scoreboards. The selected masks are configured to multiplex dependencies between the scoreboards for single or multi-strand operations.

### BACKGROUND OF THE INVENTION

1. Field of the Invention

The present invention relates to microprocessor architecture, specifically to microprocessors with instruction dependency scoreboards.

2. Description of the Related Art

Generally, out of order microprocessors use scoreboards to track instruction dependencies. An instruction is issued when all the dependencies for that instruction are cleared. The size of a scoreboard depends on the number of instructions the microprocessor tracks simultaneously. A larger scoreboard increases the number of instructions that are potentially ready to be issued in any given cycle. Larger scoreboards offer better architectural performance than smaller ones. However, as the number of instructions tracked in the scoreboard increases, the access time of the structure implementing the scoreboard also increases.

One possible solution to larger scoreboards is to split scoreboard into a fast scoreboard and a slow scoreboard. The fast scoreboard caches and tracks critical dependencies (e.g., nearest age-order dependency) and the slow scoreboard tracks the remaining older age-order dependencies of the instructions. However, tracking dependencies in two different scoreboards require complicated multiplexing architecture to split instructions according to the age-order with respect to an instruction that is being considered for issuance. Thus, a method and apparatus is needed to separate nearest age-order instructions from older age-order instructions for multiple dependencies scoreboards.

### SUMMARY

In an embodiment, the present invention describes a method of providing select mask for a hierarchical instruction dependency scoreboard. The method includes generating a first group of select masks for a first group of instructions immediately preceding a group of instructions and selecting a second group of select masks from the first group of select masks using a write pointer. The method further includes fetching the group of instructions. The method further includes determining a current octet for a current instruction, selecting a select mask for a first instruction of the current octet from a truth table, generating a first group of select masks for each instruction in the current octet, determining whether one of the group of instructions belong to a next octet.

The method further includes, if one of the group of instructions belong to a next octet, selecting a select mask for a first instruction of the next octet from the truth table, generating a second group of select masks for each instruction in the next octet, selecting the second group of select masks using the write pointer from the first and second groups of select masks. The method further includes receiving one or more of the dependencies of the group of instructions. The method further includes populating the dependencies in a slow dependency scoreboard. The method further includes selecting a first group of dependencies from the dependencies using the second group of select masks. The method further includes determining whether populating the first group of dependencies in a fast dependency scoreboard require a wrap-around, if populating the first group of dependencies in the fast dependency scoreboard require a wrap-around, identifying one or more of the dependencies that require wrap-around from the first group of dependencies, deleting the dependencies that require wrap-around from the first group of dependencies, and populating remaining dependencies from the first group of dependencies in the fast dependency scoreboard.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and numerous objects, features, and advantages made apparent to those skilled in the art by referencing the accompanying drawing.

FIG. 1 illustrates an example of functional architecture of scorebording unit in an out of order processors.

FIG. 2A illustrates an example of populating dependency masks in dependency scoreboards according to an embodiment of the present invention.

FIG. 2B illustrates an example of fast dependency multiplexer circuit according to an embodiment of the present invention.

FIG. 3A illustrates an example of a truth table that can be used to generate select masks for the first instruction of every octet in a fast dependency scoreboard according to an embodiment of the present invention.

FIG. 3B illustrates an example of select masks generated for the current and next octets using a predetermined truth table according to an embodiment of the present invention.

FIG. 3C illustrates an example of final select mask picked using the lower order bits of the write pointer for current instruction according to an embodiment of the present invention.

FIG. 4A illustrates an example of select mask generation for a multi-strand operation in an out of order processor according to an embodiment of the present invention.

FIG. 4B illustrates an example of final select mask picked using the write pointer for current instruction in multi-strand mode according to an embodiment of the present invention.

### DETAILED DESCRIPTION OF THE INVENTION

The following is intended to provide a detailed description of an example of the invention and should not be taken to be limiting of the invention itself. Rather, any number of variations may fall within the scope of the invention which is defined in the claims following the description.

Introduction

According to an embodiment of the present invention, a method and apparatus is described for selecting dependencies between fast scoreboard and slow scoreboards. The processor fetches instructions in groups of eight instructions. Each group of eight instructions is mod-eight rotated. The instructions in the scoreboards are configured into multiple octets. A select mask for the first instruction of each octet is generated using a predefined truth table. The select masks for remaining instructions in the octets are generated using the first mask. The write pointer for the current instruction is used to select the masks for the group of eight instructions. The selected masks are then used to multiplex dependencies between the scoreboards. The selected masks are configured to multiplex dependencies between the scoreboards for single or multi-strand operations.

Functional Architecture

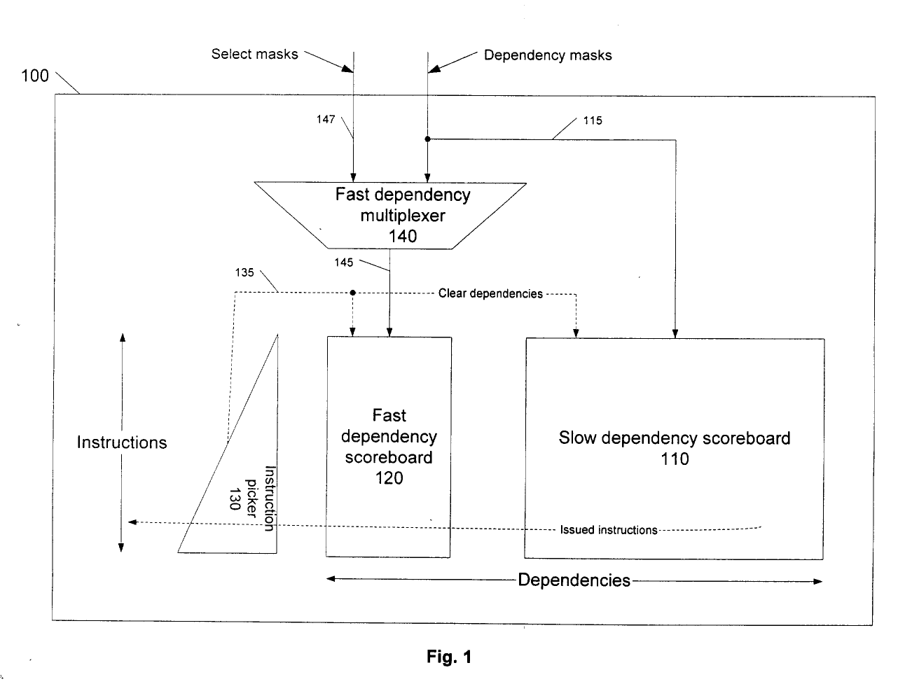

FIG. 1 illustrates an example of functional architecture of scorebording unit 100 in an out of order processor 100. Processor 100 includes a slow dependency scoreboard 110. Slow dependency scoreboard tracks the dependencies of large number of instructions (e.g., immediately preceding 128 instructions of the current instruction or the like). A fast dependency scoreboard 120 tracks critical nearest age-older instructions (e.g., immediately preceding 32 instructions of the current instruction or the like). An instruction picker 130 selects instructions from slow dependency scoreboard 110 and fast dependency scoreboard 120 for executions. Instruction picker 130 selects instructions whose dependencies are cleared. Instruction picker 130 is functionally coupled to fast dependency scoreboard 120 and slow dependency scoreboard 110.

After issuing an instruction for execution, instruction picker 130 clears any dependencies on the issued instruction in slow dependency scoreboard 110 and fast dependency scoreboard 120. Dependency masks are generated by instruction renaming unit (not shown) and received by a fast dependency multiplexer 140 on a link 115. Link 115 can be one or more communication paths required to populate dependency masks for slow dependency scoreboard 110. Fast dependency multiplexer 140 receives select masks 147 from a select logic (not shown) to select critical nearest age-older instructions (e.g., immediately preceding 32 instructions of the current instruction or the like) for fast dependency scoreboard 120.

Dependency Masks

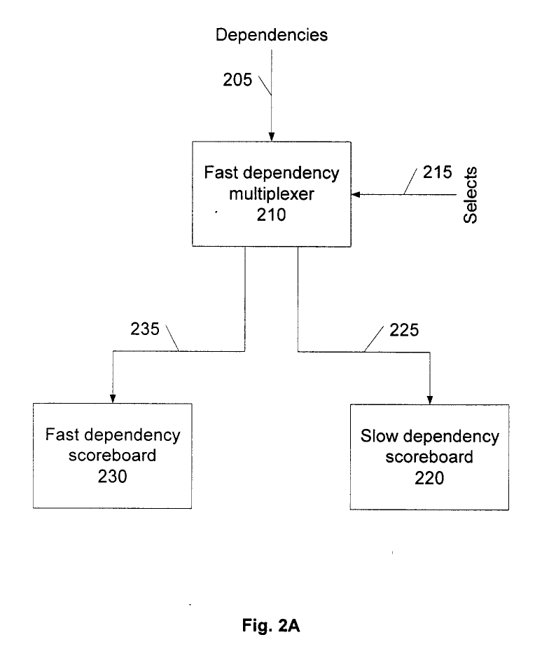

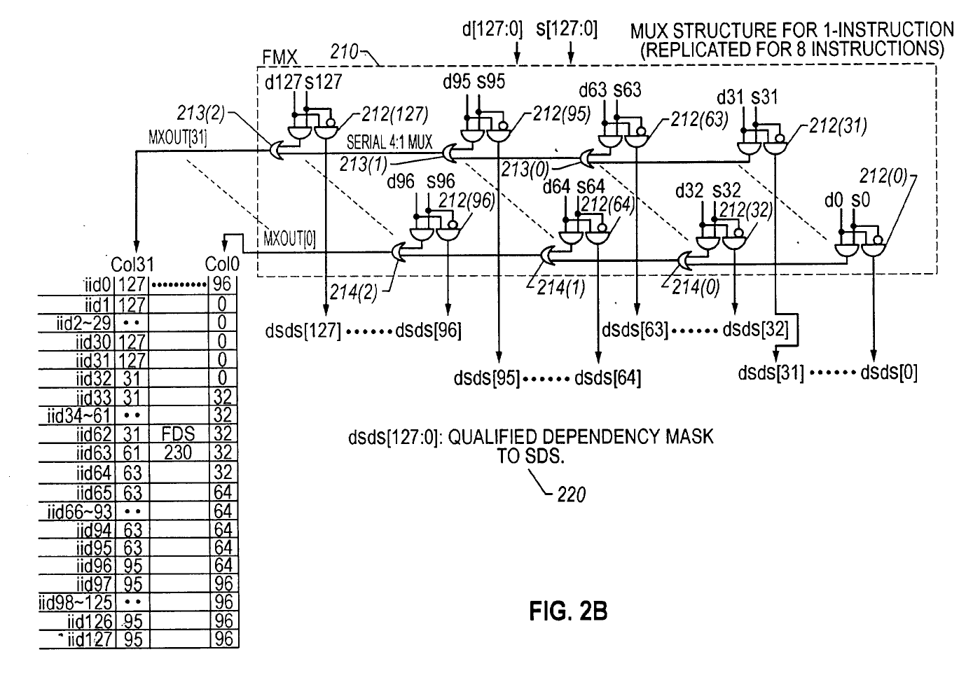

FIG. 2A illustrates an example of populating dependency masks in dependency scoreboards according to an embodiment of the present invention. Dependency masks in the dependency scoreboards can be populated according the functional architecture of out of order processors. A fast dependency multiplexer (FDM) 210 receives instruction dependencies from instruction unit (not shown) via a link 205. Fast dependency multiplexer receives selects from a select logic (not shown) on a link 215. FDM 210 selects large number of instructions (e.g., immediately preceding 128 instructions of the current instruction or the like) for slow dependency scoreboard 220 via a link 225 and critical nearest age-older instructions (e.g., immediately preceding 32 instructions of the current instruction or the like) for fast dependency scoreboard 230 via a link 235.

FIG. 2B illustrates an example of fast dependency multiplexer circuit (e.g., fast dependency multiplexer 210 or the like) according to an embodiment of the present invention. For purposes of illustration, in the present example, fast dependency scoreboard 230 maintains 128 instructions and tracks each instruction's dependencies on 32 immediately preceding instructions. Slow dependency scoreboard maintains a 128×128 matrix to track dependencies of 128 instructions on immediately preceding 128 instructions. The rows in fast dependency scoreboard 230 represents instructions, identified by instruction ID (“iid”), and columns represent dependencies. For example, for instruction 32 with iid32, fast dependency scoreboard 230 tracks dependencies of iid32 (if any) on instructions 0-31 and so on.

Dependency masks d[127:0] are generated by an instruction renaming unit (not shown) in the out of order processor. The select masks s[127:0] are generated by a select logic (not shown). In the present example, eight instructions are fetched at any given time by the out of order processor. The dependency in each column is populated on mod-32 basis using the instruction ID of each instruction. In the current example, each column in fast dependency scoreboard 230 can accommodate four possible dependencies. Each dependency mask and select mask is processed by a pair of multiplexers 212(0)-(127). Four dependency masks are multiplexed together using serial multiplexers 213(0)-(2) and 214(0)-(2). The select masks s[127:0] select 32 immediately preceding dependency masks for each instruction. Remaining masks are populated in slow dependency scoreboard 220. According to an embodiment of the present invention, 32 immediately preceding dependency masks for each instruction are duplicated in slow dependency scoreboard 220. One skilled in art will appreciate that the scoreboards can be of any size to track any number of instructions desired.

Select Masks

According to an embodiment of the present invention, the instructions are organized in an octet form. For example, iid0-8 form an octet, iid9-15 form next octet and so on. The 32 immediately preceding dependencies for each instruction are predetermined. For example, for iid32, the immediately preceding 32 dependencies can be on iid0-iid31. Similarly, for iid64, immediately preceding 32 dependencies can be on iid63-iid32 and so on. The select masks for first instruction of each octet is predetermined and the select masks for remaining instructions in the same octet are generated by rotating the mask. For example, the select mask for iid0 is predetermined and the select mask for ii1 is generated by rotating once the select mask of iid0, the select mask for iid2 is generated by rotating twice the select mask for iid0 and so on.

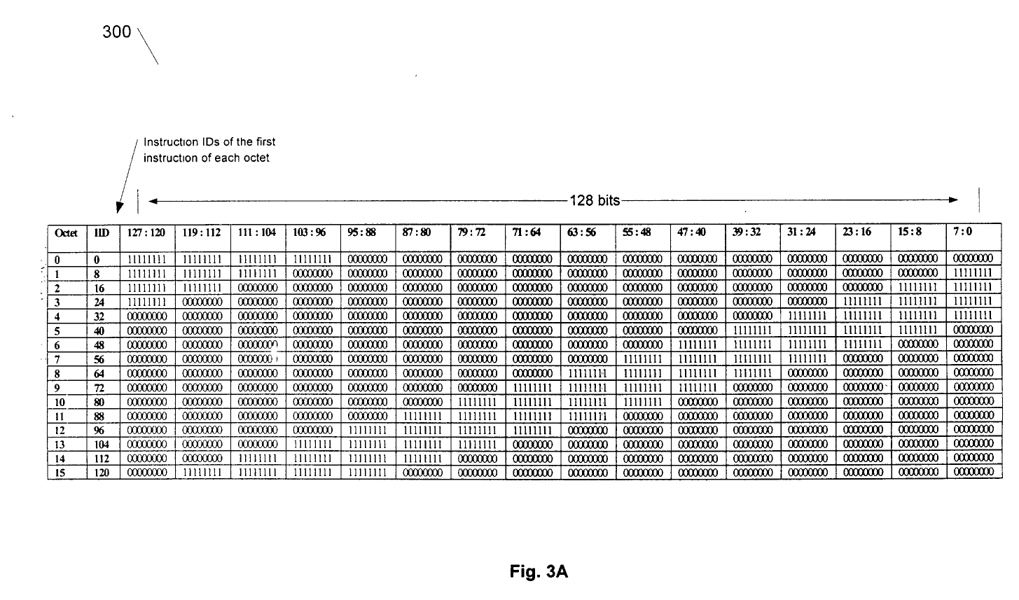

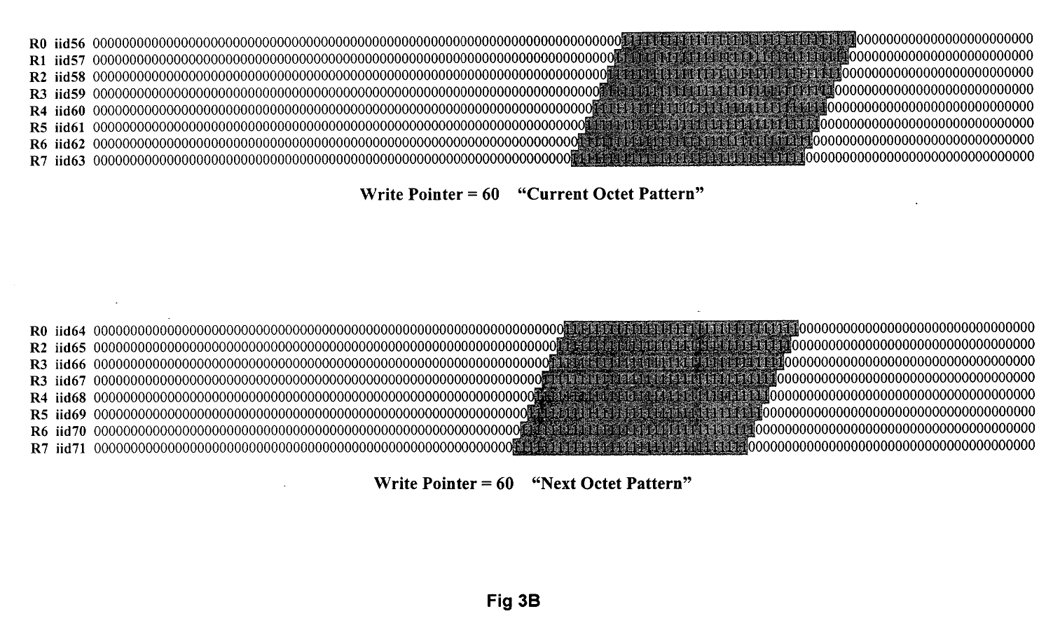

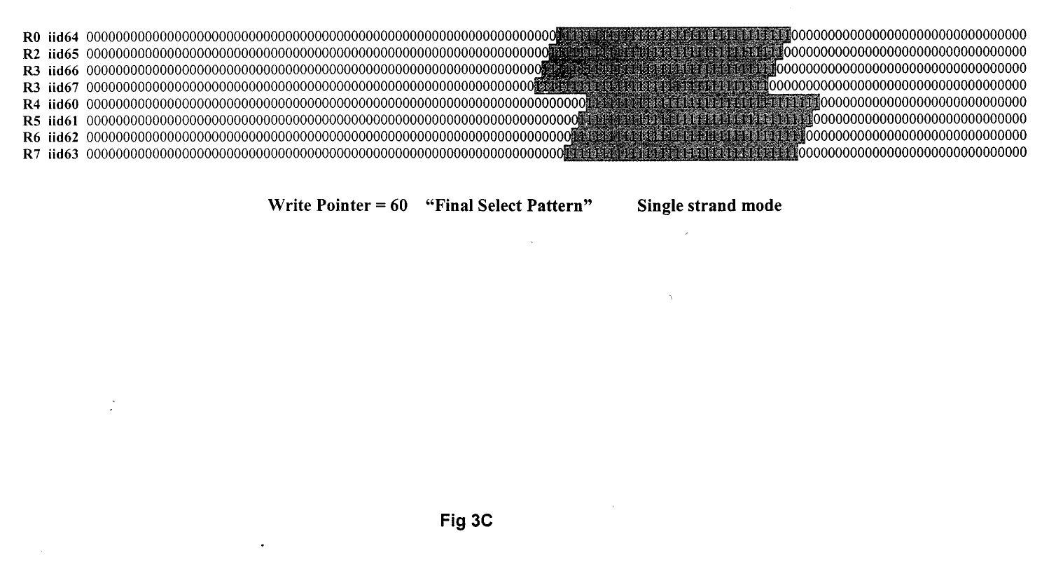

FIG. 3A illustrates an example of a truth table 300 that can be used to generate select masks for the first instruction of every octet in fast dependency scoreboard 230 according to an embodiment of the present invention. In the present example, fast dependency scoreboard 230 maintains 128 instructions, iid0-iid127, and tracks dependencies of these instructions on 32 immediately preceding instructions. Instructions in fast dependency scoreboard 230 are grouped into 16 octets, octets 0-15. However, instructions can be considered without grouping or using different grouping schemes. Truth table 300 defines 16 select masks for the first instruction of each octet. Each mask is 128 bits wide with each bit representing select for a preceding instruction (e.g., bit 31 represents 31^{st} preceding instruction and so on).

In the present example, each mask includes ‘ones’ for 32 immediately preceding instructions out of 128 instructions and ‘zeros’ for remaining instructions. For example, the select mask for iid32 includes ‘ones’ for bits 31-0, representing selects for 32 immediately preceding instructions, iid31-iid0 and ‘zeros’ for remaining instructions. The select masks defined in truth table 300 can be used to further determine the select masks for remaining instructions in the octet. It will be apparent to one skilled in art while 32 immediately preceding masks for each instruction are shown however, any number of masks in any order or form can be defined using the truth table. Similarly, the select masks can be defined using any instruction (e.g., beginning from last instruction, identifying a predetermined mask for every instruction or the like). The select masks generated using truth table 300 can be used to select dependency masks in a multiplexer (e.g., fast dependency multiplexer 210 or the like).

Example of Select Mask Generation

According to an embodiment of the present invention, the out of order processor fetches a bundle of eight instructions. The instructions fetched by the out of order processor are mod-8 rotated by the instruction renaming unit. The instruction renaming unit rotates instructions using the iid of each instruction. The instructions fetched can spread over more than one octet in fast dependency scoreboard 230. The instruction ID of the current instruction (e.g., the first instruction in the bundle identified by the wire pointer) determines the ‘current octet’ for select mask. For purpose of illustration, in the present example, the out of order processor fetches eight instructions beginning at instruction ID, iid60. The instructions fetched are iid60-iid67. The instruction unit mod-8 rotates fetched instructions using the iid's. Table 1 illustrates an example of the order of instructions before they are fetched.

TABLE 1
The order of instructions before fetching, the write pointer is at iid60.

| Instruction ID | Iid mod 8 |
|---|---|
| iid60 | 4 |
| iid61 | 5 |
| iid62 | 6 |
| iid63 | 7 |
| iid64 | 0 |
| iid65 | 1 |
| iid66 | 2 |
| iid67 | 3 |

The instruction unit reorders the instructions according to the mod-8 values. Table 2 illustrates an example of the order of the instructions after the instructions are mod-8 rotated by the instruction unit.

TABLE 2
The order of the instructions after mod-8 rotation.

| Instruction order | Instruction ID |
|---|---|
| 0 | iid64 |
| 1 | iid65 |
| 2 | iid66 |
| 3 | iid67 |
| 4 | iid60 |
| 5 | iid61 |
| 6 | iid62 |
| 7 | iid63 |

The current instruction pointer (“write pointer”) points at instruction iid60. The current octet for iid60 is octet 7. Instructions iid64-iid67 fall in octet 8 which is the next octet. Because the fetched instructions spread over two octets, the out of order processor generates two sets of select masks. The first set of select masks (e.g., current octet select mask) is generated using the first instruction of octet 7 (current octet) which is iid56. The second set of select masks (e.g., next octet select mask) is generated using the first instruction of octet 8 (next octet) which is iid64.

FIG. 3B illustrates an example of select masks generated for the current and next octets using predetermined truth table (e.g., table 300) according to an embodiment of the present invention. The write pointer points to iid60. The next step in generating select mask for immediately preceding 32 instructions for current instruction group (i.e., iid60 - iid67) is to select a pattern that includes a portion of select masks for instructions that are in current octet 7 (i.e., iid60-iid63) and the remaining instructions (i.e., iid64-iid67) from select mask pattern of octet 8.

The select mask pattern for eight instructions is picked using the write pointer. The write pointer points to the first instruction in the bundle out of 128 instructions available in the scoreboards. The write pointer is 7 bits wide, bits a0-a6. Table 3 illustrates an example of the write pointer according to an embodiment of the present invention.

TABLE 3
An example of Write pointer.

| | | | | | | |
|---|---|---|---|---|---|---|
| a6 | a5 | a4 | a3 | a2 | a1 | a0 |

FIG. 3C illustrates an example of final select mask picked using the write pointer for current instruction according to an embodiment of the present invention. The four most significant bits of the write pointer, bits a6-a3, are used to select the octet and three least significant bits, bits a2-a0 are used to select the row inside the octet determined by the four most significant bits. For example, for iid60, the write pointer is 0111100. The four most significant bits ‘0111’ indicate octet 7 and three least significant bits ‘100’ indicate row four in octet 7. Thus the pick logic can pick the select mask indicated by row 4 of octet 7 (e.g., as shown in FIG. 3B). Similarly, the write pointer of iid67 is ‘1000011’. The four most significant bits ‘1000’ indicate octet 8 which is the next octet and three least significant bits ‘110’ indicate row three in the next octet. Thus, when the select mask patterns are generated using the truth table, the select masks for currently fetched instructions can be picked using the current write pointer. While a certain number of bits are used in the foregoing example for illustration purpose, one skilled in the art will appreciate that the parameter (e.g., number of instructions fetched, write pointer, number of instructions maintained by the score boards and the like) can be of any size.

According to an embodiment of the present invention, the method of generating the select mask can be used to generate select masks for multi strand instructions mode. In multi strand instruction mode, the out of order processor fetches instructions for one or more instruction strands that can be executed simultaneously. According to an embodiment of the present invention, the instructions in various strands do not have inter-strand dependencies.

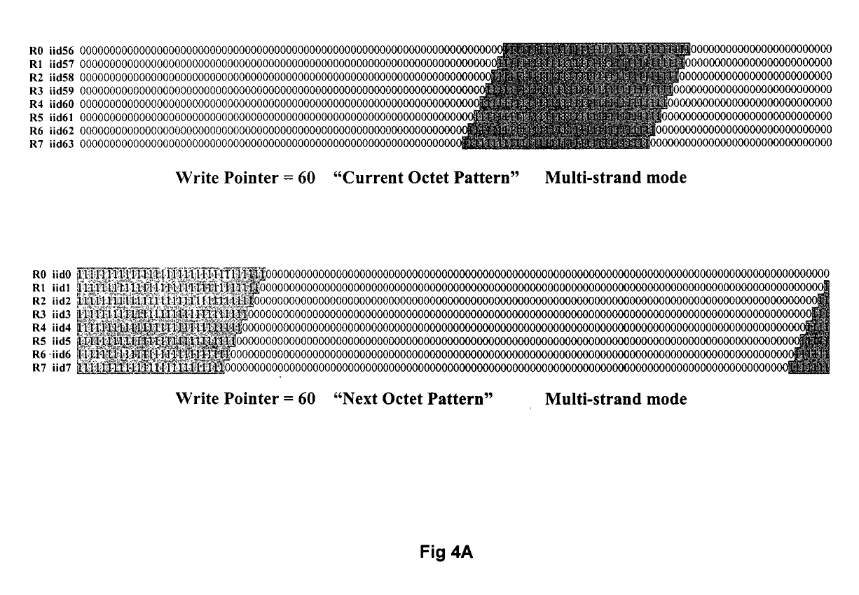

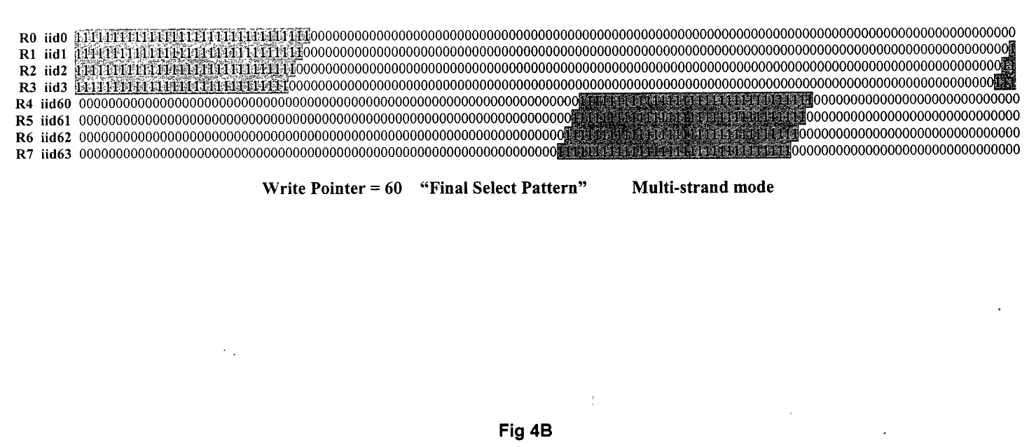

FIG. 4A illustrates an example of select mask generation for a multi-strand operation in an out of order processor according to an embodiment of the present invention. In the present example, two instruction strands are used however, the instructions can be configured into multiple strands using various number of instructions. Instruction iid0-iid63 form the first strand and iid64-iid127 form the second strand. The last instruction iid in the first strand is iid63. After iid63, the write pointer wraps around to iid0. In the present example, the write pointer points to instruction iid60 as the current instruction. The current octet for iid60 begins at iid56 thus, the select masks for the current octet are generated using iid56. Because the first instruction strand ends at iid63, the next octet begins at iid0 thus, the select masks for the next octet are generated using the select mask for iid0.

FIG. 4B illustrates an example of final select mask picked using the write pointer for current instruction in multi-strand mode according to an embodiment of the present invention. The iid64 is wrapped around to iid0 for the next octet. The most significant bit of the write pointer, bit a7, can be used to wrap around the mask selection to octet 0.

Generally, in semiconductor devices, the wrapping around of a logic require the use of critical resources (i.e., e.g., wires needed to wrap around to iid0 from the end of octet 15 in single strand mode or after the end of octet 7 in two strand mode or the like). The critical wire resources can be preserved by ‘squashing’ certain ‘corner’ dependencies. For example, when the select mask reaches the end of the last octet (e.g., octet 15 in single strand mode or the like), the mask selection can stop and the remaining dependencies for the next octet (e.g., octet 0 or the like) that require wrap around wires. The dependencies for the wrapped around corner instructions can be tracked in the slow dependency scoreboard. ‘Squashing’ reduces the number of dependencies tracked in the fast dependency scoreboard however, ‘squashing’ provides a compromising advantage over traditional slow dependency scoreboards while preserving critical wire resources in the semiconductor devices. The ‘squashing’ of corner dependencies in the select mask generation simplifies the pick logic yet still providing fast tracking of the dependencies in the fast dependency scoreboard.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method of providing select mask for a hierarchical instruction dependency scoreboard comprising:
generating a first plurality of select masks for a first plurality of instructions immediately preceding a group of instructions; and
selecting a second plurality of select masks from said first plurality of select masks using a write pointer.

2. The method of claim 1, further comprising:
fetching said group of instructions.

3. The method of claim 1, wherein said write pointer identifies a current instruction from said group of instructions.

4. The method of claim 1, wherein said group includes at least eight instructions.

5. The method of claim 4, wherein said group of instructions is mod eight rotated.

6. The method of claim 1, wherein said hierarchical instruction dependency scoreboard tracks one or more dependencies of said group of instructions on one or more of said instructions immediately preceding said group of instructions.

7. The method of claim 1, wherein said hierarchical instruction dependency scoreboard tracks said dependencies for 128 instructions.

8. The method of claim 1, wherein said said hierarchical instruction dependency scoreboard tracks said dependencies of said instructions on said first plurality of instructions immediately preceding said group of instructions.

9. The method of claim 1, wherein said hierarchical instruction dependency scoreboard comprises a fast dependency scoreboard.

10. The method of claim 9, wherein said fast dependency scoreboard tracks said dependencies of said group of instructions on at least 32 instructions immediately preceding said group of instructions.

11. The method of claim 1, wherein said hierarchical instruction dependency scoreboard further comprises a slow dependency scoreboard.

12. The method of claim 11, wherein said slow dependency scoreboard tracks said dependencies of said group of instructions on at least 128 instructions immediately preceding said group of instructions.

13. The method of claim 1, wherein said instructions in said hierarchical instruction dependency scoreboard are organized in a plurality of octets using an instruction identification of each one of said instructions.

14. The method of claim 13, wherein said hierarchical instruction dependency scoreboard is a single strand hierarchical instruction dependency scoreboard.

15. The method of claim 13, wherein said hierarchical instruction dependency scoreboard is a multi-strand hierarchical instruction dependency scoreboard.

16. The method of claim 1, wherein said first plurality of select masks is generated using a predetermined truth table.

17. The method of claim 16, wherein said truth table identifies a select mask for first instruction of each one of said plurality of octets.

18. The method of claim 2, further comprising:
determining a current octet for said current instruction;
selecting a select mask for a first instruction of said current octet from said truth table;
generating a first group of select masks for each instruction in said current octet;
determining whether one of said group of instructions belong to a next octet;
if said one of said group of instructions belong to a next octet,
selecting a select mask for a first instruction of said next octet from said truth table,
generating a second group of select masks for each instruction in said next octet,
selecting said second plurality of select masks using said write pointer from said first and second groups of select masks.

19. The method of claim 18, further comprising:
receiving one or more of said dependencies of said group of instructions.

20. The method of claim 19, further comprising:
populating said dependencies in said slow dependency scoreboard.

21. The method of claim 15, further comprising:
selecting a first group of dependencies from said dependencies using said second plurality of select masks.

22. The method of claim 21, further comprising:
determining whether populating said first group of dependencies in said fast dependency scoreboard require a wrap-around;
if populating said first group of dependencies in said fast dependency scoreboard require a wrap-around,
identifying one or more of said dependencies that require wrap-around from said first group of dependencies,
deleting said dependencies that require wrap-around from said first group of dependencies, and
populating remaining dependencies from said first group of dependencies in said fast dependency scoreboard.

23. A select mask generation system comprising:
a dependency select logic;
a fast dependency scoreboard coupled to said dependency select logic,
wherein said dependency select logic is configured to
generate a first plurality of select masks for a first plurality of instructions immediately preceding a group of instructions; and
select a second plurality of select masks from said first plurality of select masks using a write pointer.

24. The system of claim 23, wherein said fast dependency scoreboard is configured to track dependencies of a plurality of instructions on at least 32 instructions immediately preceding said plurality of instructions.

25. The system of claim 23, further comprising:
a slow dependency scoreboard coupled to said dependency select logic,
wherein said slow dependency scoreboard is configured to track said dependencies of said plurality of instructions on at least 128 instructions immediately preceding said plurality of instructions.

26. The system of claim 23, further comprising:
an instruction picker unit coupled to said fast dependency scoreboard, wherein said instruction picker is configured to select an instruction that is ready for execution.

27. The system of claim 26, wherein said instruction that is ready for execution do not have said dependencies.

28. The system of claim 26, wherein said instruction picker is coupled to said slow dependency scoreboard.

29. The system of claim 26, wherein an out of order processor comprises said select mask generation system.

30. The system of claim 23, wherein said dependency select logic is further configured to
determine a current octet for said current instruction;
select a select mask for a first instruction of said current octet from said truth table;
generate a first group of select masks for each instruction in said current octet;
determine whether one of said group of instructions belong to a next octet;
if said one of said group of instructions belong to a next octet;
select a select mask for a first instruction of said next octet from said truth table;
generate a second group of select masks for each instruction in said next octet;
select said second plurality of select masks using said write pointer from said first and second groups of select masks.

31. The system of claim 30, wherein said dependency select logic is further configured to
receive one or more of said dependencies of said group of instructions.

32. The system of claim 31, wherein said dependency select logic is further configured to
populate said dependencies in said slow dependency scoreboard.

33. The system of claim 32, wherein said dependency select logic is further configured to
select a first group of dependencies from said dependencies using said second plurality of select masks.

34. The system of claim 33, wherein said dependency select logic is further configured to
determine whether populating said first group of dependencies in said fast dependency scoreboard require a wrap-around;
if populating said first group of dependencies in said fast dependency scoreboard require a wrap-around,
identify one or more of said dependencies that require wrap-around from said first group of dependencies;
delete said dependencies that require wrap-around from said first group of dependencies; and
populate remaining dependencies from said first group of dependencies in said fast dependency scoreboard.

35. A system for providing select mask for a hierarchical instruction dependency scoreboard comprising:
means for generating a first plurality of select masks for a first plurality of instructions immediately preceding a group of instructions; and
means for selecting a second plurality of select masks from said first plurality of select masks using a write pointer.

36. The system of claim 35, further comprising:
means for fetching said group of instructions.

37. The system of claim 35, wherein said write pointer identifies a current instruction from said group of instructions.

38. The system of claim 35, wherein said group includes at least eight instructions.

39. The system of claim 38, wherein said group of instructions is mod eight rotated.

40. The system of claim 35, wherein said hierarchical instruction dependency scoreboard tracks one or more dependencies of said group of instructions on one or more of said instructions immediately preceding said group of instructions.

41. The system of claim 35, wherein said hierarchical instruction dependency scoreboard tracks said dependencies for 128 instructions.

42. The system of claim 35, wherein said hierarchical instruction dependency scoreboard tracks said dependencies of said instructions on said first plurality of instructions immediately preceding said group of instructions.

43. The system of claim 35, wherein said hierarchical instruction dependency scoreboard comprises a fast dependency scoreboard.

44. The system of claim 43, wherein said fast dependency scoreboard tracks said dependencies of said group of instructions on at least 32 instructions immediately preceding said group of instructions.

45. The system of claim 35, wherein said hierarchical instruction dependency scoreboard further comprises a slow dependency scoreboard.

46. The system of claim 45, wherein said slow dependency scoreboard tracks said dependencies of said group of instructions on at least 128 instructions immediately preceding said group of instructions.

47. The system of claim 35, wherein said instructions in said hierarchical instruction dependency scoreboard are organized in a plurality of octets using an instruction identification of each one of said instructions.

48. The system of claim 47, wherein said hierarchical instruction dependency scoreboard is a single strand hierarchical instruction dependency scoreboard.

49. The system of claim 47, wherein said hierarchical instruction dependency scoreboard is a multi-strand hierarchical instruction dependency scoreboard.

50. The system of claim 35, wherein said first plurality of select masks is generated using a predetermined truth table.

51. The system of claim 50, wherein said truth table identifies a select mask for first instruction of each one of said plurality of octets.

52. The system of claim 36, further comprising:
means for determining a current octet for said current instruction;
means for selecting a select mask for a first instruction of said current octet from said truth table;
means for generating a first group of select masks for each instruction in said current octet;
means for determining whether one of said group of instructions belong to a next octet;
means for selecting a select mask for a first instruction of said next octet from said truth table if said one of said group of instructions belong to a next octet;
means for generating a second group of select masks for each instruction in said next octet if said one of said group of instructions belong to a next octet;
means for selecting said second plurality of select masks using said write pointer from said first and second groups of select masks if said one of said group of instructions belong to a next octet.

53. The system of claim 52, further comprising:
means for receiving one or more of said dependencies of said group of instructions.

54. The system of claim 53, further comprising:
means for populating said dependencies in said slow dependency scoreboard.

55. The system of claim 54, further comprising:
means for selecting a first group of dependencies from said dependencies using said second plurality of select masks.

56. The system of claim 55, further comprising:
means for determining whether populating said first group of dependencies in said fast dependency scoreboard require a wrap-around;
means for identifying one or more of said dependencies that require wrap-around from said first group of dependencies if populating said first group of dependencies in said fast dependency scoreboard require a wrap-around;
means for deleting said dependencies that require wrap-around from said first group of dependencies if populating said first group of dependencies in said fast dependency scoreboard require a wrap-around; and
means for populating remaining dependencies from said first group of dependencies in said fast dependency scoreboard if populating said first group of dependencies in said fast dependency scoreboard require a wrap-around.
